(19) United States
(12) Patent Application Publication
(10) Pub. No.: US 2026/0003692 A1
(43) Pub. Date: Jan. 1, 2026

(54) REGISTER FILE PACKING

(71) Applicant: Advanced Micro Devices, Inc., Santa Clara, CA (US)

(72) Inventors: Steven Gregory Flolid, Austin, TX (US); John Kalamatianos, Boxborough, MA (US)

(21) Appl. No.: 18/758,818

(22) Filed: Jun. 28, 2024

(51) Int. Cl. G06F 9/50

(52) U.S. Cl. CPC G06F 9/5044; G06F 9/5022

(57) ABSTRACT

A central processing unit (CPU) is disclosed. The CPU includes: a physical register file (PRF) including a plurality of physical registers; an instruction queue configured to store an instruction identifying an opcode, a source operand register, and a destination operand register; and an allocator, configured to allocate a first physical register to the destination operand register, where the first physical register has a first changeable bit size corresponding with a result bit size of the destination operand register.

### BACKGROUND

Conventional register files operate by having instruction operands or outputs assigned to particular address locations therein. For example, for each instruction, the operands and output(s) thereof are assigned physical memory locations in a physical register file (PRF). The available locations in the PRF have sizes which correspond to a maximum allowable size of operands and outputs for the system.

### BRIEF DESCRIPTION OF THE DRAWINGS

For a more complete understanding of the present invention, and the advantages thereof, reference is now made to the following descriptions taken in conjunction with the accompanying drawings.

FIG. 1 illustrates a schematic block diagram of a portion of a central processing unit (CPU) connected to a memory according to some implementations.

FIG. 2 illustrates a schematic block diagram of an allocator circuit used, for example, in the CPU portion of FIG. 1 according to some implementations.

FIG. 3 illustrates a schematic representation of a set of sub-allocators, and a PRF at a first and second times.

FIG. 4 illustrates a schematic representation of a PRF according to some implementations.

FIG. 5 illustrates a method of operating a CPU circuit according to some implementations.

Corresponding numerals and symbols in the different figures generally refer to corresponding parts unless otherwise indicated. The figures are drawn to clearly illustrate the relevant aspects of the implementations and are not necessarily drawn to scale. The edges of features drawn in the figures do not necessarily indicate the termination of the extent of the feature.

### DETAILED DESCRIPTION OF ILLUSTRATIVE IMPLEMENTATIONS

The making and using of various implementations are discussed in detail below. It should be appreciated, however, that the various implementations described herein are applicable in a wide variety of specific contexts. The specific implementations discussed are merely illustrative of specific ways to make and use various implementations, and should not be construed in a limited scope.

Reference to “an implementation,” “one implementation,” “an embodiment,” or “one embodiment” in the framework of the present description is intended to indicate that a particular configuration, structure, or characteristic described in relation to the implementation/embodiment is included in at least one implementation/embodiment. Hence, phrases such as “in one implementation” or “in one embodiment” that may be present in one or more points of the present description do not necessarily refer to one and the same implementation/embodiment. Moreover, particular conformations, structures, or characteristics may be combined in any adequate way in one or more implementations/embodiments. The references used herein are provided merely for convenience and hence do not define the extent of protection or the scope of the implementations/embodiments.

In order for a CPU to execute instructions, the operands and outputs or results of the instructions are associated with registers in a physical register file (PRF). Operational codes (opcodes) and physical register numbers (PRNs) or addresses of the registers are provided to an arithmetic logic unit (ALU) for execution. In order to execute the instruction, the ALU uses an opcode to determine an operation to be performed on the operands. Accordingly, the ALU provides the data in the operand registers to ALU circuits associated with the opcode. The ALU circuits function according to the data in the operand registers, and generate one or more outputs. The ALU provides data corresponding with the outputs to one or more output or result registers associated with the instruction.

An allocator circuit is used to temporarily assign or allocate registers in the PRF to operands and results of the instructions. The allocator circuit may also deallocate the registers in the PRF so that the registers may be used for other instructions.

Because operands and results of the instructions have different sizes, the registers of the PRF may correspondingly have different sizes. For example, some operands or results may be 128 or more bits, while other operands or results may be, for example, 64 bits, 32 bits, or 16 bits. It is worth noting that some CPU architecture embodiments treat all data as the same bit size, while other CPU architecture embodiments support different sized destination results based on the compiled or estimated size of an instruction's destination.

The allocator circuit may be configured to assign operands and results of the instructions to registers corresponding with the sizes of the assigned operands and results. For example, operands or results having a size of 128 bits may be assigned to registers of the PRF having a size of 128 bits, and operands or results having a size of 32 bits may be assigned to registers of the PRF having a size of 32 bits. Assigning operands and results of the instructions to registers having corresponding sizes allows for efficient use of the PRF.

In addition, during a series of executed instructions, the distribution of operand or result sizes may differ over time. Accordingly, the distribution of the sizes of the registers of the PRF may correspondingly differ over time.

To adjust the distribution of the sizes of the registers of the PRF, the allocator circuit may be configured to dynamically designate addresses (or PRNs) or ranges of addresses (or PRNs) of registers of the PRF as being available for use for a particular size of operand or result. For example, a first variable portion or set of addresses or address ranges of the PRF may be designated as being available for use for operands or results having a size of 128 bits, and a second variable portion or set of addresses or address ranges of the PRF may be designated as being available for use for operands results having the size of 64 bits. In some implementations, the allocator circuit may be configured to dynamically change the designations, for example, based on instruction operand or result usage, as described in more detail below.

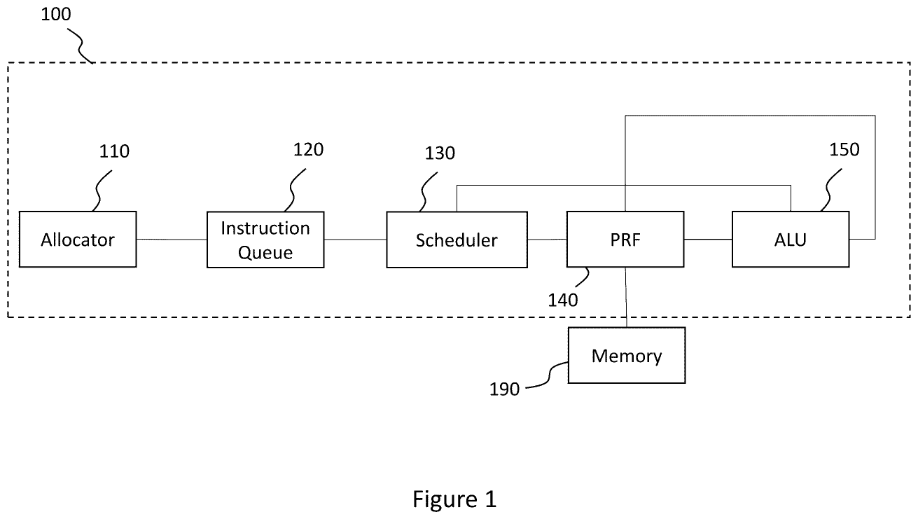

FIG. 1 illustrates a schematic block diagram of a portion of a central processing unit (CPU) 100 connected to a memory 190 according to some implementations. CPU 100 includes PRF allocator 110, instruction queue 120, instruction scheduler 130, physical register file 140, and arithmetic logic unit (ALU) circuit 150. In some implementations, the CPU 100 may include other functional elements to perform calculations and instruction execution.

In some implementations, PRF allocator 110 designates physical register addresses in the PRF 140 for instructions. For example, a particular instruction may include references to a number of instruction operands and instruction results. In order for the particular instruction to be executed, the instruction operands and instruction outputs are each associated with a particular register address in the PRF 140.

To determine which physical register addresses to assign to particular results, PRF allocator 110 may be configured to determine or estimate a size for each of the particular results and to designate registers of the PRF 140 of corresponding sizes for the particular results.

In addition, the distribution of operand or result sizes may differ over time, for example, according to which instructions of which applications are being executed. Accordingly, at least to improve PRF efficiency, the distribution of the sizes of the available registers of the PRF 140 may correspondingly differ over time.

To adjust the distribution of the sizes of the registers of the PRF 140, PRF allocator 110 may be configured to dynamically designate addresses or ranges of addresses of registers of the PRF 140 as being available for use for a particular size of result. For example, a first set of addresses or address ranges of the PRF 140 may be designated as being available for use for results having a first size, and a second set of addresses or address ranges of the PRF 140 may be designated as being available for use for results having a second size.

In some implementations, the PRF allocator 110 may be configured to dynamically change the designations. For example, the PRF allocator 110 may be configured to determine current usage of each of a number of sets of addresses or address ranges designated for each size. In addition, the PRF allocator 110 may be configured to adjust the designations according to the current usage. For example, if a first set of addresses or address ranges designated as being available for a first size of results is greater than a first threshold portion of being completely used and a second set of addresses or address ranges designated as being available for a second size of results is less than a second threshold portion of being completely used, the PRF allocator 110 may be configured to remove a portion of the first set of addresses or address ranges from the first set and add them to the second set of addresses or address ranges.

In some implementations, instruction queue 120, for example, is a buffer that stores instructions prefetched from a memory before they are executed by the CPU 100. The instruction queue may be used to temporarily store prefetched impending instructions while the processor is executing a current instruction. The fetching of instructions in advance, prior to their need for execution, boosts its efficiency.

Instruction scheduler 130 is configured to receive instructions from instruction queue 120. In addition, instruction scheduler 130 is configured to cause ALU circuit 150 to execute instructions from instruction queue 120 by providing opcodes of the instructions to ALU circuit 150 and by providing signals to physical register file (PRF) 140, where the signals cause PRF 140 to provide operand data stored in the PRF 140 corresponding with the operand registers of the instructions, and where the signals cause PRF 140 to store result data of the executed instructions from ALU circuit 150 in the result registers of the executed instructions. In some implementations, the signals additionally cause PRF 140 to provide operand data and/or result data to memory 190.

When instructions are compiled, they may be compiled at a certain operand size. However, when executed, the instructions may produce results that are much smaller. In such cases, an estimator/predictor can identify the opportunity to allocate a smaller PRN for the destination operand than the compiled size. In some implementations, these predictions can be based off the instruction pointer or memory address of the instruction.

In some implementations, instruction scheduler 130 is configured to verify size estimates of source operand or destination operand registers. If the size estimates resulted in registers of insufficient or incorrect sizes to be allocated to the source operands or destination operands, instead of causing the ALU circuit 150 to execute the instructions, the instruction scheduler 130 causes the CPU pipeline to be flushed.

In some implementations, instruction scheduler 130 is configured to provide an indication to PRF allocator 110 that an instruction has been or is about to be executed. In some implementations, instruction scheduler 130 is configured to provide an indication to PRF allocator 110 that one or more destination operand registers is to be deallocated, for example, as a result of an instruction having been or being about to be executed.

In some implementations, in response to the indication from instruction scheduler 130, PRF allocator 110 is configured to deallocate the identified destination operand registers. As a result, those physical addresses in the PRF 140 allocated to the identified destination operand registers are no longer allocated thereto, and are thereafter available for allocation to other destination operand registers.

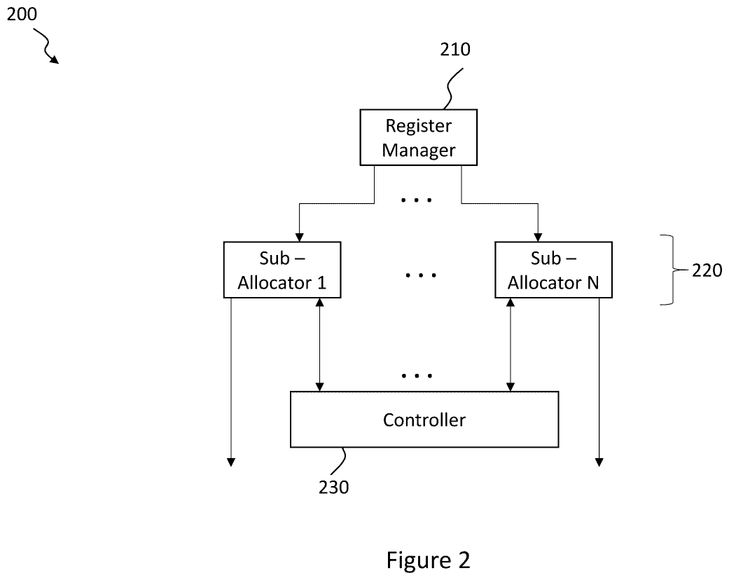

FIG. 2 illustrates a schematic block diagram of a PRF allocator circuit 200 used, for example, as PRF allocator 110 in the CPU 100 of FIG. 1 according to some implementations. PRF allocator circuit 200 includes register manager 210, sub-allocators 1-N 220, and controller 230.

In some implementations, register manager 210 receives instructions from, for example, an instruction queue, such as instruction queue 120.

In some implementations, register manager 210 analyzes destination operand register identifiers in the instructions received from the instruction queue. Results of the analysis include determining which destination operand register identifiers are currently associated with addresses or address ranges in a PRF. Results of the analysis also include determining which destination operand register identifiers are not currently associated with addresses or address ranges in the PRF. Results of the analysis also include determining or estimating bit sizes of the destination operand registers associated with the destination operand register identifiers.

In some implementations, register manager 210 determines which of the sub-allocators 220 is to be used for assigning PRF addresses for the destination operand registers. In some implementations, register manager 210 makes the determination based on the determined or estimated bit sizes of the destination operand registers. For example, register manager 210 may have determined that a first particular destination operand register has a bit size of 2^{(N+3)}=16 bits for N=1, and may, based on that bit size, determine that the first particular destination operand register is to be assigned a PRF address by sub-allocator (N=)1 of the sub-allocators 220. Similarly, register manager 210 may have determined that a second particular destination operand register has a bit size of 2^{(N+3)} bits, and may, based on that bit size, determine that the second particular destination operand register is to be assigned a PRF address by the Nth sub-allocator of the sub-allocators 220.

In some implementations, register manager 210 is configured to provide the destination operand register identifiers to the sub-allocators 220 according to the determined or estimated size of each of the destination operand registers. For example, register manager 210 may be configured to provide each of the destination operand registers having a bit size of 16 bits to sub-allocator 1 as a result of the destination operand registers having a bit size of 16 bits, and the register manager 210 may be configured to provide the destination operand registers having a bit size of 32 bits to a different sub-allocator 220 as a result of the destination operand registers having a bit size of 32 bits. Accordingly, for at least some instructions having destination operand registers of different sizes, the destination operand registers thereof may be assigned PRF addresses by different sub-allocators of the sub-allocators 220.

Each of the sub-allocators 220 is configured to designate physical register addresses (or PRNs) of the PRF for the destination operand register identifiers received from register manager 210. In some implementations, each particular sub-allocator is configured to store a list of physical register addresses or address ranges that are available thereto for allocation. In some implementations, the physical register addresses or address ranges for each particular sub-allocator correspond with a physical register size associated with the particular sub-allocators.

In addition, in some implementations, each sub-allocator 220 stores an allocation indication, such as a flag, for each register available thereto as to whether the register is currently allocated. For example, if a sub-allocator 220 has allocated a particular physical register with an instruction destination operand register, the allocation indication associated with the particular physical register indicates that the particular physical register is currently allocated.

In some implementations, in order for a particular sub-allocator 220 to allocate a particular instruction destination operand register to a physical register, the particular sub-allocator 220 selects a next available physical register, as determined by the allocation indication of the next available physical register indicating that the next available physical register is not currently allocated. Once the next available physical register is identified, an address or PRN of the next available physical register is provided to, for example, a scheduler, such as instruction scheduler 130 of FIG. 1.

In some implementations, controller 230 is configured to receive an indication that one or more destination operand registers are to be deallocated, for example, as a result of an instruction having been or about to be executed. In some implementations, in response to the indication, controller 230 is configured to communicate the indication to a particular sub-allocator 220 having the destination operand register to be deallocated as available for allocation. In some implementations, in response to the indication, controller 230 is configured to communicate the indication to all of the sub-allocators 220 as available for allocation.

In some implementations, in response to receiving the communicated indication, the sub-allocator 200 having the destination operand register to be deallocated, deallocates the identified destination operand registers. As a result, those physical addresses in the PRF 140 allocated to the identified destination operand registers are no longer allocated thereto, and are thereafter available for allocation to other destination operand registers.

Because the distribution of result sizes may vary over time, for example, according to which instructions of which applications are being executed, at least to improve PRF efficiency, the distribution of the sizes of the available registers of the PRF 140 may be correspondingly controlled and modified over time.

To adjust the distribution of the sizes of the registers of the PRF 140, controller 230 may be configured to dynamically designate addresses or ranges of addresses of registers of the PRF 140 as being available for each of the sub-allocators 220. For example, a first set of addresses or address ranges of the PRF 140 may be designated as being available for use by a first sub-allocator 220 associated with a first PRF register size, and a second set of addresses or address ranges of the PRF 140 may be designated as being available for use by a second sub-allocator associated with a second PRF register size. In some implementations, the controller 230 may be configured to dynamically change the designations. For example, controller 230 may be configured to determine a current utilization ratio for each of the sub-allocators 220, where each utilization ratio indicates a portion of the PRF registers available to the sub-allocator 220 which are currently allocated. In addition, controller 230 may be configured to adjust the designations according to the current utilization ratios. For example, if a first utilization ratio of a first sub-allocator 220 is greater than a first threshold and if a second utilization ratio of a second sub-allocator 220 is less than a second threshold, controller 230 may be configured to remove a portion of the first set of addresses or address ranges from being available to the first sub-allocator 220 and add them to those available to the second sub-allocator 220.

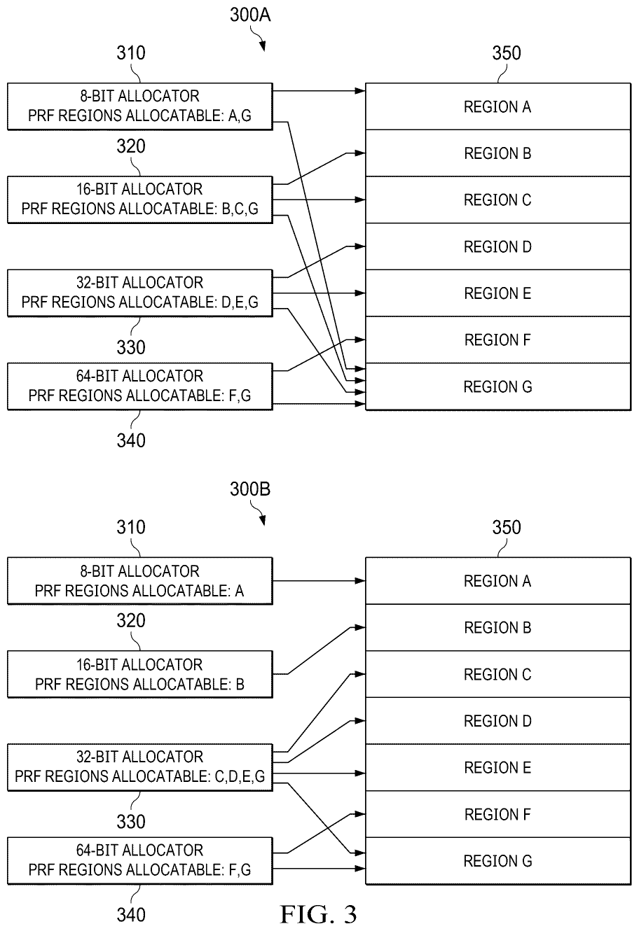

FIG. 3 illustrates a schematic representation of a set of sub-allocators 310, 320, 330, and 340, and a PRF 350 in a first state 300A and in a second state 300B, according to some implementations. The sub-allocators 310, 320, 330, and 340 may have characteristics and functionality which is similar or identical to the sub-allocators discussed elsewhere herein. PRF 350 may have characteristics and functionality which is similar or identical to the PRF's discussed elsewhere herein.

At a first time, for example, as a result of control signals from a controller (not shown), in first state 300A, sub-allocators 310, 320, 330, and 340 are configured to allocate and deallocate physical registers of PRF 350 as indicated. Accordingly, in the first state 300A, sub-allocator 310 is configured to allocate and deallocate physical registers of regions A and G of PRF 350. Similarly, sub-allocator 320 is configured to allocate and deallocate physical registers of regions B, C, and G of PRF 350; sub-allocator 330 is configured to allocate and deallocate physical registers of regions D, E, and G of PRF 350; and sub-allocator 340 is configured to allocate and deallocate physical registers of regions F and G of PRF 350.

At a second time, for example, as a result of control signals from a controller (not shown), in second state 300B, sub-allocators 310, 320, 330, and 340 are configured to allocate and deallocate physical registers of PRF 350 as indicated. Accordingly, in the second state 300B, sub-allocator 310 is configured to allocate and deallocate physical registers of region A of PRF 350. Similarly, sub-allocator 320 is configured to allocate and deallocate physical registers of region B of PRF 350; sub-allocator 330 is configured to allocate and deallocate physical registers of regions C, D, E, and G of PRF 350; and sub-allocator 340 is configured to allocate and deallocate physical registers of regions F and G of PRF 350.

In some implementations, a physical section of PRF 350 may at different times be associated with different sub allocators, and may, therefore, be at different times part of different regions. For example, in some implementations, in a first state, a particular section of PRF 350 has 64 bits, and, a first through eighth 8-bit subsections (i.e., subsections 1-8) may be allocated to a single 64-bit destination operand register by sub-allocator 340. In addition, in a second state, subsections 1-4 of the particular section of PRF 350 may be allocated to a first 32-bit destination operand register by sub-allocator 330, and subsections 5-8 of the particular section of PRF 350 may be allocated to a second 32-bit destination operand register by sub-allocator 330.

In addition, in a third state, subsections 1-4 of the particular section of PRF 350 may be allocated to a 32-bit destination operand register by sub-allocator 330, subsections 5 and 6 of the particular section of PRF 350 may be allocated to a 16-bit destination operand register by sub-allocator 320, subsection 7 of the particular section of PRF 350 may be allocated to a first 8-bit destination operand register by sub-allocator 310, and subsection 8 of the particular section of PRF 350 may be allocated to a second 8-bit destination operand register by sub-allocator 310. Accordingly, in some implementations, each subsection of PRF 350 may be allocated to a destination operand register of any size supported by the sub-allocators.

In some implementations, between the first time and the second time, the controller determined that sub-allocator 330 should be able to allocate registers from a greater portion of the PRF 350, and that sub-allocators 310 and 320 should be able to allocate registers from a lesser portion of the PRF 350.

As indicated in the illustrated implementation, region G of PRF 350 has physical registers which may be allocated by multiple sub-allocators. In alternative implementations, each region of PRF 350 has physical registers which may be allocated by only a single sub-allocator.

In some implementations, each of the regions of PRF 350 has a same number of bits. In alternative implementations, the regions of PRF 350 have a different number of bits. In some implementations, the regions of PRF 350 have a changeable number of bits.

As indicated by the illustrated implementation, in some implementations, in some states, portions of PRF 350 associated with a particular sub-allocator are contiguous. In some implementations, in some states, portions of PRF 350 associated with a particular sub-allocator are not contiguous.

It is to be noted that, in some implementations, when a particular region is designated as available to a particular sub-allocator and is no longer available to a previous sub-allocator, the contents of the particular region are not modified. Accordingly, the particular region will still contain data of the size associated with the previous sub-allocator until all of those pieces of register data are deallocated at some eventual future point in time.

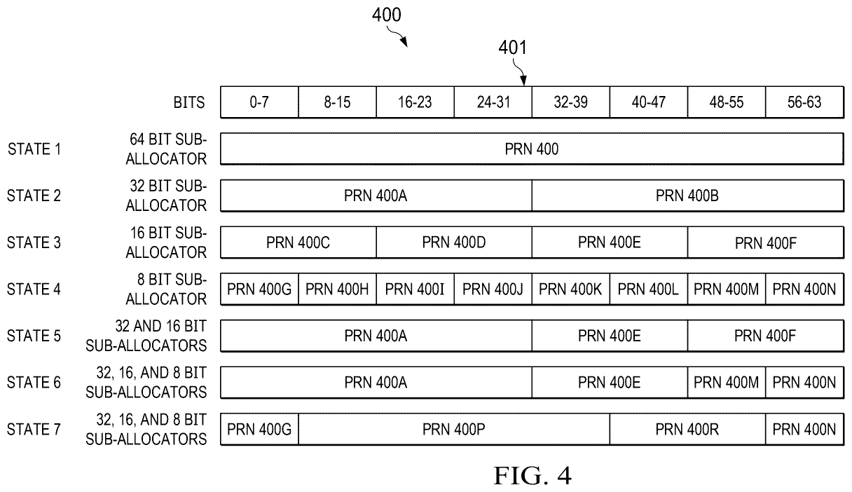

FIG. 4 illustrates a schematic representation of an 8-byte section 401 of a PRF at different states according to some implementations. Section 401 may, at different times, be associated with different sub allocators, and may, therefore, be at different times part of different regions. The states discussed with reference to FIG. 4 are to be understood as a relatively small set of examples of the numerous states which are possible.

During state 1, the eight byte section 401 may be allocated by the 64-bit sub-allocator to a single 64 bit destination operand register, and is, therefore part of a region available to the 64-bit sub-allocator. In this state, the eight byte section 401 is addressed with a single PRN 400.

During state 2, the eight byte section 401 may be allocated by the 32-bit sub-allocator to first and second 32-bit source operand or destination operand registers, and is, therefore part of regions available to the 64-bit sub-allocator and to the 32-bit sub-allocator. In this state, a first portion of the eight byte section 401 may be allocated to the first 32 bit destination operand register, and is addressed with PRN 400A, and a second portion of the eight byte section 401 may be allocated to the second 32-bit destination operand register, and is addressed with PRN 400B.

During state 3, the eight byte section 401 may be allocated by the 16-bit sub-allocator to first, second, and fourth 16-bit destination operand registers, and is, therefore part of a region available to the 16-bit sub-allocator. In this state, a first portion of the eight byte section 401 may be allocated to the first 16-bit destination operand register, and is addressed with PRN 400C, a second portion of the eight byte section 401 may be allocated to the second 16-bit destination operand register, and is addressed with PRN 400D, a third portion of the eight byte section 401 may be allocated to the third 16-bit destination operand register, and is addressed with PRN 400E, and a fourth portion of the eight byte section 401 may be allocated to the fourth 16-bit destination operand register, and is addressed with PRN 400F.

During state 4, the eight byte section 401 may be allocated by the 8-bit sub-allocator to first through eighth 8-bit destination operand registers, and is, therefore part of a region available to the 8-bit sub-allocator. In this state, each of the eight portions of the eight byte section 401 may be allocated to a different 8-bit destination operand register, and may be addressed with one of PRN 400G through PRN 400N.

During state 5, the eight byte section 401 may be allocated by the 32-bit sub-allocator to a 32 bit destination operand register and may be allocated by the 16-bit sub-allocator to first and second 16 bit destination operand registers, and is, therefore part of regions available to the 32-bit sub-allocator and to the 16-bit sub-allocator. In this state, a first portion of the eight byte section 401 may be allocated to the 32 bit destination operand register, and is addressed with PRN 400A, a second portion of the eight byte section 401 may be allocated to the first 16-bit destination operand register, and is addressed with PRN 400E, and the third portion of the eight byte section 401 may be allocated to the second 16 bit destination operand register, and is addressed with PRN 400F.

During state 6, the eight byte section 401 may be allocated by the 32-bit sub-allocator to a 32 bit destination operand register, may be allocated by the 16-bit sub-allocator to a 16 bit destination operand register, and may be allocated by the 8-bit sub-allocator to first and second 8 bit destination operand registers, and is, therefore part of regions available to the 32-bit sub-allocator, to the 16-bit sub-allocator, and to the 8-bit sub-allocator. In this state, a first portion of the eight byte section 401 may be allocated to the 32 bit destination operand register, and is addressed with PRN 400A, a second portion of the eight byte section 401 may be allocated to the 16-bit destination operand register, and is addressed with PRN 400E, a third portion of the eight byte section 401 may be allocated to the first 8-bit destination operand register, and is addressed with PRN 400M, and a fourth portion of the eight byte section 401 may be allocated to the second 8-bit destination operand register, and is addressed with PRN 400N.

During state 7, the eight byte section 401 may be allocated by the 32-bit sub-allocator to a 32 bit destination operand register, may be allocated by the 16-bit sub-allocator to a 16 bit destination operand register, and may be allocated by the 8-bit sub-allocator to first and second 8 bit destination operand registers, and is, therefore part of regions available to the 32-bit sub-allocator, to the 16-bit sub-allocator, and to the 8-bit sub-allocator In this state, a first portion of the eight byte section 401 may be allocated to the first 8-bit destination operand register, and is addressed with PRN 400G, a second portion of the eight byte section 401 may be allocated to the 32 bit destination operand register, and is addressed with PRN 400A, a third portion of the eight byte section 401 may be allocated to the 16-bit destination operand register, and is addressed with PRN 400E, and a fourth portion of the eight byte section 401 may be allocated to the second 8-bit destination operand register, and is addressed with PRN 400N.

In some implementations, before transitioning from one state to another, a controller determines that the current assignment of the various sections of the PRF is to be changed, and reassigns some of the sections of the PRF to different sub-allocators, for example, as discussed elsewhere herein. For example, the controller may reassign some of the sections of the PRF to different sub-allocators, such that the eight byte section 401 may transition from any of states 1-7 or any other state to any other of states 1-7 or another state.

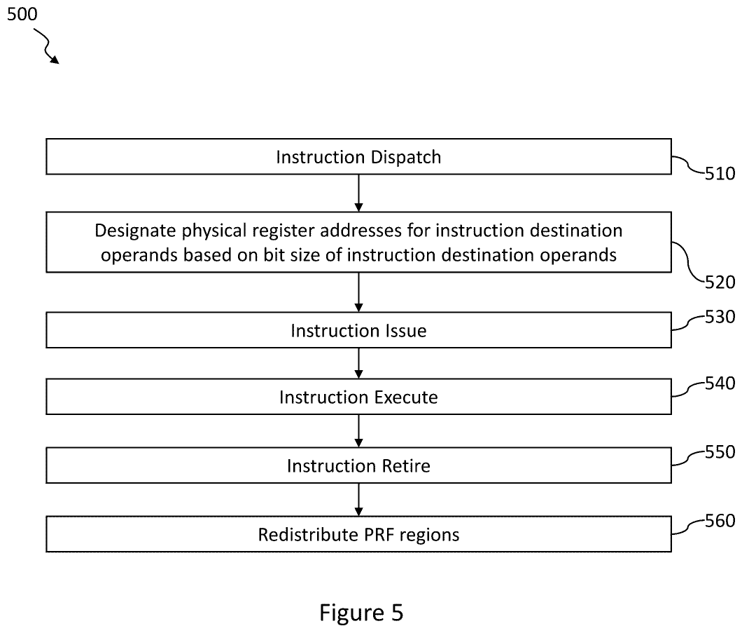

FIG. 5 illustrates a method 500 of operating a CPU circuit according to some implementations. Method 500 may be performed, for example by the CPU of FIG. 1.

In some implementations, at block 510, an instruction queue, such as instruction queue 120, is configured to store instructions prefetched from memory before they are executed by a processor. In some implementations, the instruction queue is configured to store instructions as part of an instruction dispatch operation, module, or circuit.

In some implementations, at block 520, an allocator, such as PRF allocator 110 designates physical register addresses of a PRF for the destination operands of the instructions of the instruction queue. For example, a particular instruction in the instruction queue may include identifiers for a number of destination operands. The allocator associates each of the destination operands with a particular register address in the PRF based on the bit-size of the destination operand.

To determine which physical register addresses to assign to particular destination operands, the allocator may be configured to determine a size for each of the particular destination operands and to designate registers of the PRF of corresponding sizes for the particular destination operands.

In addition, because the distribution of destination operand sizes may differ over time, for example, according to which instructions of which applications are being executed, at least to improve PRF efficiency, the allocator may dynamically modify the distribution of the sizes of the available registers of the PRF over time. For example, to adjust the distribution of the sizes of the registers of the PRF, the allocator dynamically designate addresses or ranges of addresses of registers of the PRF as being available for use for a particular size of destination operand. For example, the allocator may determine current utilization for each of a number of sub-allocators managing registers of the PRF of a particular size, and may adjust the designations of which registers are available to each sub-allocator according to the current utilization. For example, if a first sub-allocator has allocated a high portion of registers available thereto, and a second sub-allocator has allocated a low portion of registers available thereto, the allocator may redesignate some of the register capacity of the second sub-allocator to the first sub-allocator.

In some implementations, at block 530, an instruction scheduler, such as instruction scheduler 130 receives instructions from the instruction queue after the allocator has allocated physical register addresses to the destination operands of the instructions. In addition, the instruction scheduler may provide opcodes of the instructions to an ALU circuit, such as ALU circuit 150, may cause the ALU circuit to receive data from source operand registers of the PRF associated with the source operands of the instructions, and may cause the ALU circuit to receive a PRF address for one or more destination operands of the instructions.

In some implementations, at block 540, the ALU circuit executes the instructions by providing the data of source operand registers of the instructions to circuitry identified by the opcodes of the instructions, causing the identified circuitry to generate one or more destination operands, and to store the destination operands in the destination registers of the instructions. In some implementations, the destination operands are additionally or alternatively stored in a memory according to the instructions.

In some implementations, at block 550, the instruction scheduler or another circuit provides an indication to the allocator that one or more destination operand registers is to be deallocated, for example, as a result of an instruction having been or being about to be executed. In some implementations, in response to the indication, the allocator deallocates the identified destination operand registers. As a result, those physical addresses in the PRF allocated to the identified destination operand registers are no longer allocated thereto, and are thereafter available for allocation to other destination operand registers.

In some embodiments, at block 560, the scheduler may modify the distribution of the sizes of the available registers of the PRF according to a current or recent distribution of destination operand sizes. For example, to adjust the distribution of the sizes of the registers of the PRF the scheduler may dynamically designate addresses or ranges of addresses of registers of the PRF as being available for each of a number of sub-allocators of the scheduler.

One general aspect is a central processing unit (CPU), including a physical register file (PRF) including a plurality of physical registers; an instruction queue configured to store an instruction identifying an opcode, a source operand register, and a destination operand register; and an allocator, configured to allocate a first physical register to the destination operand register, where the first physical register has a first changeable bit size corresponding with a result bit size of the destination operand register.

Implementations may include one or more of the following features. The CPU, where the allocator is configured to change a bit size of the first physical register. The CPU, where the allocator includes first and second sub-allocators, where the first sub-allocator is configured to allocate physical registers having the first changeable bit size to destination operand register registers having the first changeable bit size, where the second sub-allocator is configured to allocate physical registers having a second bit size to destination operand register registers having a changeable second bit size, and where the first and second changeable bit sizes are different. The CPU, where the first sub-allocator is configured to deallocate physical registers having the first changeable bit size from destination operand register registers having the first changeable bit size, where the second sub-allocator is configured to deallocate physical registers having the second changeable bit size from destination operand register registers having the second changeable bit size. The CPU, where the allocator includes a controller configured to designate a first set of addresses of registers of the PRF as being available to the first sub-allocator for allocation, where the first set of addresses identify registers of the PRF having the first changeable bit size, and where the controller is configured to designate a second set of addresses of registers of the PRF as being available to the second sub-allocator for allocation, where the second set of addresses identify registers of the PRF having the second bit size. The CPU, where the controller is configured to designate a third set of addresses of registers of the PRF as being available to the first sub-allocator for allocation, where the third set of addresses identify registers of the PRF having the first changeable bit size, where the third set of addresses is different from the first set of addresses. The CPU, where the controller is configured to determine the third set of addresses based on utilization ratios for the first sub-allocator. The CPU, where the instruction identifies a source operand register having a first bit size, where the instruction identifies a destination operand register having a second bit size, and where the first and second bit sizes are different. The CPU, where a particular portion of the PRF is part of a first register at a first time, and where the particular portion of the PRF is part of a second register at a second time.

One general aspect is an allocator for a central processing unit (CPU), the allocator including a first sub-allocator, configured to allocate a first physical register of a physical register file (PRF) to a destination operand register of an instruction, where the first physical register has a first changeable bit size corresponding with an operand bit size of the destination operand register.

Implementations may include one or more of the following features. The allocator, where the first sub-allocator is configured to allocate physical registers having the first changeable bit size to destination operand registers of the changeable first bit size, where the allocator further includes a second sub-allocator configured to allocate physical registers having a second changeable bit size to destination operand registers having the second changeable bit size, and where the first and second changeable bit sizes are different. The allocator, where the first sub-allocator is configured to deallocate physical registers having the first changeable bit size from destination operand registers having the first changeable bit size, where the second sub-allocator is configured to deallocate physical registers having the second changeable bit size from destination operand registers having the changeable second bit size. The allocator, further including a controller configured to designate a first set of addresses of registers of the PRF as being available to the first sub-allocator for allocation, where the first set of addresses identify registers of the PRF having the first changeable bit size, and where the controller is further configured to designate a second set of addresses of registers of the PRF as being available to the second sub-allocator for allocation, where the second set of addresses identify registers of the PRF having the second changeable bit size. The allocator, where the controller is configured to designate a third set of addresses of registers of the PRF as being available to the first sub-allocator for allocation, where the third set of addresses identify registers of the PRF having the first changeable bit size, where the third set of addresses is different from the first set of addresses. The allocator, where the controller is configured to determine the third set of addresses based on utilization ratios for the first sub-allocator. The allocator, where a particular portion of the PRF is part of a first register at a first time, and where the particular portion of the PRF is part of a second register at a second time.

One general aspect is a method of using an allocator for a central processing unit (CPU), the method including allocating a first physical register of a physical register file (PRF) to a destination operand register of an instruction, where the first physical register has a first changeable bit size corresponding with an operand bit size of the destination operand register.

Implementations may include one or more of the following features. The method, further including deallocating physical registers having the first changeable bit size from destination operand registers having the first changeable bit size. The method, further including designating a first set of addresses of registers of the PRF as being available to a first sub-allocator for allocation, where the first set of addresses identify registers of the PRF having the first changeable bit size. The method, further including designating a third set of addresses of registers of the PRF as being available to the first sub-allocator for allocation, where the third set of addresses identify registers of the PRF having the first changeable bit size, where the third set of addresses is different from the first set of addresses; and determining the third set of addresses based on a utilization ratio for the first sub-allocator.

Although the description has been described in detail, it should be understood that various changes, substitutions, and alterations may be made without departing from the spirit and scope of this disclosure as defined by the appended claims. The same elements are designated with the same reference numbers in the various figures. Moreover, the scope of the disclosure is not intended to be limited to the particular implementations described herein, as one of ordinary skill in the art will readily appreciate from this disclosure that processes, machines, manufacture, compositions of matter, means, methods, or steps, presently existing or later to be developed, may perform substantially the same function or achieve substantially the same result as the corresponding implementations described herein. Accordingly, the appended claims are intended to include within their scope such processes, machines, manufacture, compositions of matter, means, methods, or steps.

What is claimed is:

1. A central processing unit (CPU), comprising:
a physical register file (PRF) comprising a plurality of physical registers;
an instruction queue configured to store an instruction identifying an opcode, a source operand register, and a destination operand register; and
an allocator, configured to:
allocate a first physical register to the destination operand register, wherein the first physical register has a first changeable bit size corresponding with a result bit size of the destination operand register.

2. The CPU of claim 1, wherein the allocator is configured to change a bit size of the first physical register.

3. The CPU of claim 1, wherein the allocator comprises first and second sub-allocators, wherein the first sub-allocator is configured to allocate physical registers having the first changeable bit size to destination operand register registers having the first changeable bit size, wherein the second sub-allocator is configured to allocate physical registers having a second bit size to destination operand register registers having a changeable second bit size, and wherein the first and second changeable bit sizes are different.

4. The CPU of claim 3, wherein the first sub-allocator is configured to deallocate physical registers having the first changeable bit size from destination operand register registers having the first changeable bit size, wherein the second sub-allocator is configured to deallocate physical registers having the second changeable bit size from destination operand register registers having the second changeable bit size.

5. The CPU of claim 3, wherein the allocator comprises a controller configured to designate a first set of addresses of registers of the PRF as being available to the first sub-allocator for allocation, wherein the first set of addresses identify registers of the PRF having the first changeable bit size, and wherein the controller is configured to designate a second set of addresses of registers of the PRF as being available to the second sub-allocator for allocation, wherein the second set of addresses identify registers of the PRF having the second bit size.

6. The CPU of claim 5, wherein the controller is configured to designate a third set of addresses of registers of the PRF as being available to the first sub-allocator for allocation, wherein the third set of addresses identify registers of the PRF having the first changeable bit size, wherein the third set of addresses is different from the first set of addresses.

7. The CPU of claim 6, wherein the controller is configured to determine the third set of addresses based on utilization ratios for the first sub-allocator.

8. The CPU of claim 1, wherein the instruction identifies a source operand register having a first bit size, wherein the instruction identifies a destination operand register having a second bit size, and wherein the first and second bit sizes are different.

9. The CPU of claim 1, wherein a particular portion of the PRF is part of a first register at a first time, and wherein the particular portion of the PRF is part of a second register at a second time.

10. An allocator for a central processing unit (CPU), the allocator comprising:
a first sub-allocator, configured to allocate a first physical register of a physical register file (PRF) to a destination operand register of an instruction, wherein the first physical register has a first changeable bit size corresponding with an operand bit size of the destination operand register.

11. The allocator of claim 10, wherein the first sub-allocator is configured to allocate physical registers having the first changeable bit size to destination operand registers of the changeable first bit size, wherein the allocator further comprises a second sub-allocator configured to allocate physical registers having a second changeable bit size to destination operand registers having the second changeable bit size, and wherein the first and second changeable bit sizes are different.

12. The allocator of claim 11, wherein the first sub-allocator is configured to deallocate physical registers having the first changeable bit size from destination operand registers having the first changeable bit size, wherein the second sub-allocator is configured to deallocate physical registers having the second changeable bit size from destination operand registers having the changeable second bit size.

13. The allocator of claim 11, further comprising a controller configured to designate a first set of addresses of registers of the PRF as being available to the first sub-allocator for allocation, wherein the first set of addresses identify registers of the PRF having the first changeable bit size, and wherein the controller is further configured to designate a second set of addresses of registers of the PRF as being available to the second sub-allocator for allocation, wherein the second set of addresses identify registers of the PRF having the second changeable bit size.

14. The allocator of claim 13, wherein the controller is configured to designate a third set of addresses of registers of the PRF as being available to the first sub-allocator for allocation, wherein the third set of addresses identify registers of the PRF having the first changeable bit size, wherein the third set of addresses is different from the first set of addresses.

15. The allocator of claim 14, wherein the controller is configured to determine the third set of addresses based on utilization ratios for the first sub-allocator.

16. The allocator of claim 10, wherein a particular portion of the PRF is part of a first register at a first time, and wherein the particular portion of the PRF is part of a second register at a second time.

17. A method of using an allocator for a central processing unit (CPU), the method comprising:
allocating a first physical register of a physical register file (PRF) to a destination operand register of an instruction, wherein the first physical register has a first changeable bit size corresponding with an operand bit size of the destination operand register.

18. The method of claim 17, further comprising: deallocating physical registers having the first changeable bit size from destination operand registers having the first changeable bit size.

19. The method of claim 18, further comprising designating a first set of addresses of registers of the PRF as being available to a first sub-allocator for allocation, wherein the first set of addresses identify registers of the PRF having the first changeable bit size.

20. The method of claim 19, further comprising:
designating a third set of addresses of registers of the PRF as being available to the first sub-allocator for allocation, wherein the third set of addresses identify registers of the PRF having the first changeable bit size, wherein the third set of addresses is different from the first set of addresses; and
determining the third set of addresses based on a utilization ratio for the first sub-allocator.
